(19) United States
(12) Patent Application Publication
(10) Pub. No.: US 2016/0191645 A1
(43) Pub. Date: Jun. 30, 2016

(54) Containerizing Web Applications for Managed Execution

(71) Applicant: Citrix Systems, Inc., Fort Lauderdale, FL (US)

(72) Inventors: Richard Hayton, Cambridge (GB); Chris Mayers, Cambridge (GB)

(21) Appl. No.: 14/585,320

(22) Filed: Dec. 30, 2014

(51) Int. Cl. H04L 29/08; H04L 12/861; H04L 29/06

(52) U.S. Cl. CPC H04L 67/2842; H04L 67/42; H04L 49/90; H04L 67/02

(57) ABSTRACT

Aspects described herein are directed toward systems, methods, devices, and non-transitory computer-readable media for containerizing a web application and managing its execution. In example implementations, at least a portion of a web application a resource list identified by that web application is retrieved. The portion of the web application and the resources retrieved are cached at a computing device. The application manager intercepts one or more function calls invoked at the cached portion of the web application and processes the function calls intercepted.

### FIELD

The present application is generally directed toward application management and is directed, in particular, to controlling the functionality of web applications.

### BACKGROUND

The use of mobile computing devices continues to grow. Accordingly enterprises have embraced the use of mobile computing devices to remotely access enterprise resources. Such resources may include, for example, electronic mail services, file services, applications, data, and other types of electronic resources maintained and made accessible by an enterprise. Due to the convenience of accessing enterprise resources remotely, users have shown an increased interest in using mobile computing devices to access those resources. To preserve the security of the enterprise resources, however, an enterprise may seek to place control or limitations on the computing devices with respect to the functions those devices are permitted to perform, the resources those devices are permitted to access, and the interactions those devices are permitted to engage in with other devices.

To maintain this control, an enterprise may employ various management techniques. Some solutions have included issuing users enterprise-owned devices that are entirely managed by the enterprise using those various management techniques. To avoid having to keep and maintain multiple devices—e.g., a work device and a personal device—users might prefer to access the enterprise resources from their personal devices in a BYOD (bring-your-own-device) scenario. To ensure the security of the enterprise resources when accessed from users' personal devices, however, techniques are needed to manage those personal devices.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards controlling remote access to the resources of an enterprise computing system via web applications and containerizing those web application for managed execution.

A first aspect described herein provides a method of containerizing a web application and managing its execution. At least a portion of a web application and at least one resource utilized by the web application may be retrieved. The portion of the web application and the resources retrieved may be cached at a computing device. The application manager may intercept one or more function calls invoked at the cached portion of the web application and process the function calls intercepted.

An additional aspect described herein provide a computing device having one or more processors and memory storing instructions that, when executed by at least one of the processors cause the computing device to perform the method set forth above. Another aspect described herein provide non-transitory computer-readable media that, when executed, cause a computing device to perform the method set forth above.

Handling the intercepted function call may include invoking functionality of the application manager in lieu of the functionality invoked by the intercepted function call at the cached portion of the web application. The intercepted function call may be a network function call that invokes remote functionality at a remotely-located computing device, and processing the network function call may include applying a network policy to the network function call. Applying the network function call may include invoking functionality of the application manager in lieu of the remote functionality invoked by the network function call or proxying the network function call on behalf of the cached portion of the web application. The intercepted function call may also be a storage function call configured to store content at a local data store, and processing the storage function call may include applying a storage policy to the storage function call. The intercepted function call may also be a hardware function call configured to access local hardware, and processing the hardware function call may include applying a hardware policy to the hardware function call.

The cached portion of the web application may also be modified such that at least a portion of its functionality is subject to control by the application manager. Modifying the cached portion of the web application may include adding to the cached portion of the web application a new function call that invokes functionality of the application manager. Modifying the cached portion of the web application may also include replacing an existing function call in the cached portion of the web application with a replacement function call that invokes functionality of the application manager. Modifying the cached portion of the web application may also include removing from the cached portion of the web application reference to the resource list.

Retrieving the cached portion of the web application and a resource utilized by the web application may include retrieving a resource list referenced by the web application and one or more resources identified in the resource list. The resource list may also identify a remote web service utilized by the web application. The remote web service may be retrieved and cached at the computing device. The cached portion of the web application may then be modified to utilize the cached portion of the web service in lieu of the remote web service.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative enterprise mobility management system in accordance with one or more illustrative aspects described herein.

FIG. 4 depicts another illustrative enterprise mobility management system in accordance with one or more illustrative aspects described herein.

FIG. 5 depicts a block diagram of a system for containerizing web applications and managing operation of containerized web applications in accordance with one or more illustrative aspects described herein.

FIG. 6 depicts a block diagram of a system for containerizing web applications and web services in accordance with one or more illustrative aspects described herein.

FIG. 7 depicts an additional block diagram of a system for containerizing web applications and managing operation of containerized web applications in accordance with one or more illustrative aspects described herein.

FIG. 8 depicts a flowchart of example method steps for containerizing a web application in accordance with one or more illustrative aspects described herein.

FIG. 9 depicts a flowchart of example method steps for managing operation of a containerized web application in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed toward controlling remote access to the resources of an enterprise computing system via web applications. Techniques for caching web applications at a client computing device for offline use are employed to containerize at least a portion of the web applications and thus obtain control over the operation of the web applications at the client computing device. Subsequent to containerization of a web application, policies are applied that add to, limit, or alter functionality of the web application.

As described in further detail below, a web application is containerized by downloading and caching at least a portion of the web application at a client computing device. Containerizing the web application relies on the techniques for caching the web application at a client computing device for offline use. The web application references, includes, or otherwise identifies a resource list that indicates the resources the web application utilizes during operation which may include resources the web application utilizes to operate offline. Having cached a local copy of at least a portion of the web application and at least some of its resources at the client computing device, a client agent modifies the cached copy of the web application such that at least some of its function calls are intercepted by an application manager. Intercepting the function calls thus creates a security boundary around the cached web application, and the application manager may apply enterprise mobility management (EMM) techniques and mobile device management (MDM) techniques to control operation of the cached web application across that boundary.

Although web technologies are leveraged that allow a cached web application to operate offline, it is not a requirement that the cached web application operate offline when executing in the containerized environment. A containerized web application cached at a client computing device may thus be configured for both containerized offline operation as well as containerized online operation. In this regard, a containerized web application cached at a client computing device might utilize network connections when available but still function locally at the client computing device when one or more of those network connections becomes unavailable. As described in further detail below, however, an application manager may apply a policy (e.g., a security policy) during operation of a containerized web application cached at a client computing device that requires the cached web application to operate offline even if network connections are available. As also described in further detail below, a web application may be pre-configured for managed operation before it is downloaded and cached at a client computing device or modified for managed operation after it is downloaded and cached at the client computing device.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging. In addition a “set” as used in this description refers to a collection of one or more elements. Furthermore non-transitory computer-readable media refer to all types of computer-readable media with the sole exception being a transitory propagating signal.

As used in this description, the following terminology is adopted. Containerization refers to the process of placing a functional element under the control of a managing element that controls the operation of the functional element. Containerization includes pre-configuring a new application as well as modifying an existing application such that its functionality is subject to the control by the managing element. Pre-configuring a new application includes stubbing out the application with instructions that invoke the functionality of the managing element, e.g., using explicit calls to an Application Programming Interface (API) provided by the managing element. Modifying an existing application includes adding new instructions to the application or replacing existing instructions of the application with new instructions. The new instructions likewise invoke the functionality of the managing element. Modifying an application may occur before or after an application is delivered to a computing device. Modifying an application may also occur before or during operation of the application.

An application is one example of a functional element, and the application may be a native application or a web application. A native application refers to an executable program coded in the machine language of the hardware platform on which it executes. A web application refers to an application in which at least a portion of the application is downloaded from a remotely-located web server and is configured to interact with one or more remotely-located web-based computing devices (e.g., the web server) during execution. The web application may access the remotely-located web-based computing devices via a public network such as the Internet (i.e., the World Wide Web), via a private network, or via a combination of public and private networks such as a virtual private network (VPN). A web application is made up of various components used to render the web application and provide functionality. Example components of a web application include one or more HTML-formatted pages (HyperText Markup Language), one or more cascading style sheets (CSS), one or more scripts, and content such as images, audio files, video files, text, databases, and other types of content. These components are referred to in this description as the resources of the web application. The scripts of a web page may be written in various scripting languages such as, for example, JavaScript. A web application may be rendered by a web browser or another native application that includes a rendering engine and a pane to present the rendered portions of the web application. A web application rendered in a web browser may be referred to as a browser-based web application. A web application rendered in a native application other than a web browser may be referred to as a client-based web application. As used in this description, a web service is a type of web application. A web service refers to a functional element implemented according to a service-oriented architecture (SOA). A web application may utilize a web service to retrieve information, process data, or communicate with other web applications.

A web application may be configured to run offline when a network connection to the web server is unavailable. Current web standards define mechanisms through which a web application may be configured for offline use. As an example, the HTML Version 5 (HTML5) standard defines a feature in which a manifest lists the resources the web application uses to run offline. As used in this description, offline refers to the situation in which a connection to a remote computing device is not available. A computing device may be offline with respect to one remote computing device even though connections to other remote computing devices are available. The manifest may list, for example, the web pages, style sheets, scripts, images, and other assets the web application would use to operate when a network connection is unavailable. The manifest indicates, for each resource, the location of the resource, e.g., the URL address (Uniform Resource Locator). The web browser downloads and caches the resources listed in the manifest. When a network connection is available, the web application may retrieve the resources from the web server as needed. Should the network connection become unavailable, however, the web application may utilize the cached copies of the resources to enable continued operation of the web application while offline. The web pages of the web application may include an attribute that identifies and provides the location of the manifest for the web application.

Computing Architecture

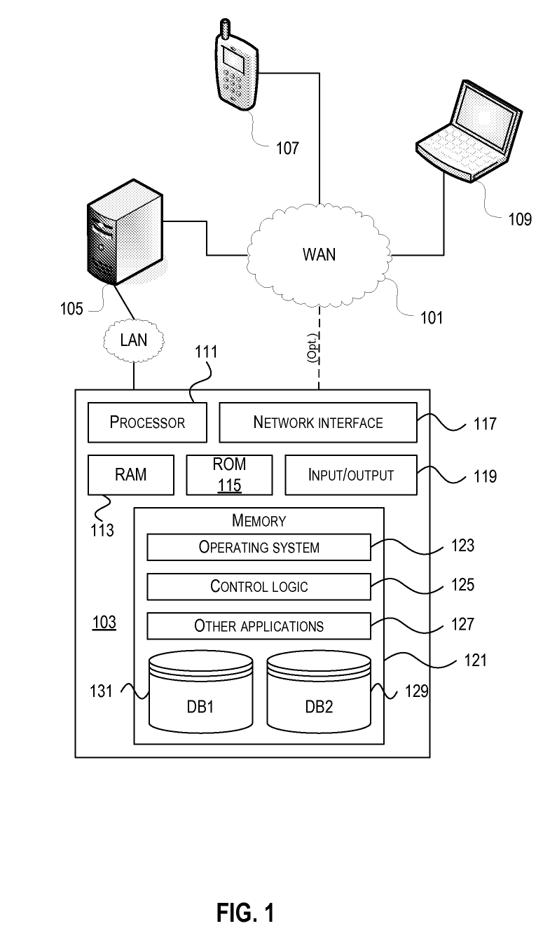

Computer software, hardware, and networks may be utilized in a variety of different system environments, including standalone, networked, remote-access (aka, remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, LANs, metropolitan area networks (MAN) wireless networks, personal networks (PAN), and the like. Network 101 is for illustration purposes and may be replaced with fewer or additional computer networks. A local area network (LAN) may have one or more of any known LAN topology and may use one or more of a variety of different protocols, such as Ethernet. Devices 103, 105, 107, 109 and other devices (not shown) may be connected to one or more of the networks via twisted pair wires, coaxial cable, fiber optics, radio waves or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the rate server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic may also be referred to herein as the data server software 125. Functionality of the data server software may refer to operations or decisions made automatically based on rules coded into the control logic, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database may include the second database (e.g., as a separate table, report, etc.). That is, the information can be stored in a single database, or separated into different logical, virtual, or physical databases, depending on system design. Devices 105, 107, 109 may have similar or different architecture as described with respect to device 103. Those of skill in the art will appreciate that the functionality of data processing device 103 (or device 105, 107, 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

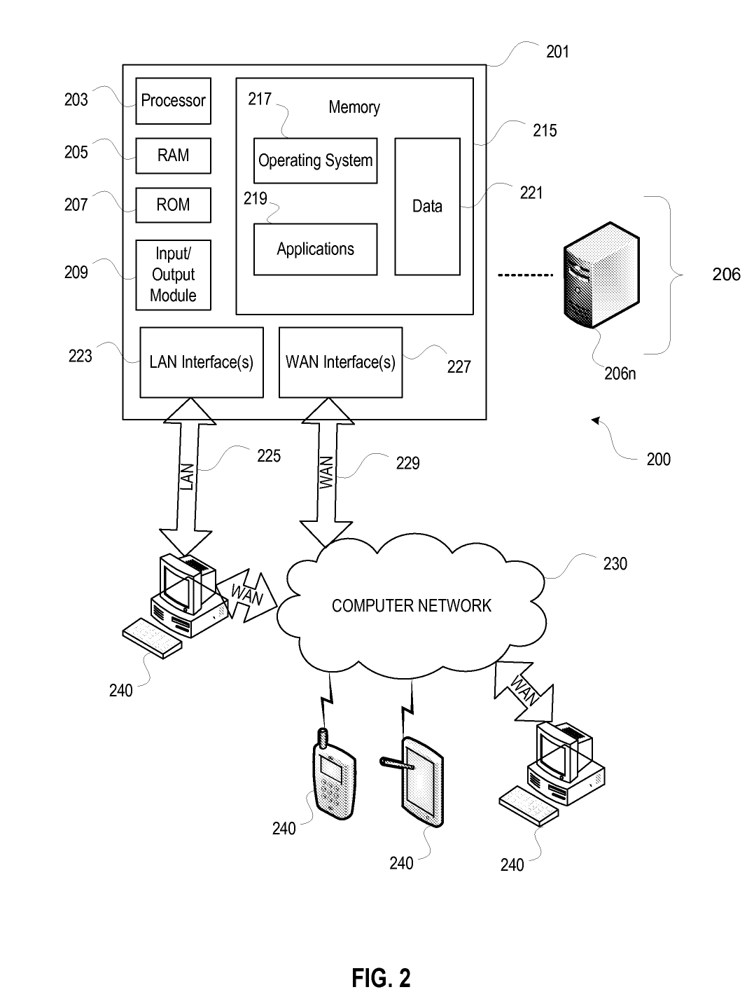

With further reference to FIG. 2, one or more aspects described herein may be implemented in a remote-access environment. FIG. 2 depicts an example system architecture including a generic computing device 201 in an illustrative computing environment 200 that may be used according to one or more illustrative aspects described herein. Generic computing device 201 may be used as a server 206a in a single-server or multi-server desktop virtualization system (e.g., a remote access or cloud system) configured to provide virtual machines for client access devices. The generic computing device 201 may have a processor 203 for controlling overall operation of the server and its associated components, including RAM 205, ROM 207, I/O module 209, and memory 215.

I/O module 209 may include a mouse, keypad, touch screen, scanner, optical reader, and/or stylus (or other input device(s)) through which a user of generic computing device 201 may provide input, and may also include one or more of a speaker for providing audio output and a video display device for providing textual, audiovisual, and/or graphical output. Software may be stored within memory 215 and/or other storage to provide instructions to processor 203 for configuring generic computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices). The terminals 240 may be personal computers, mobile devices, laptop computers, tablets, or servers that include many or all of the elements described above with respect to the generic computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem 227 or other wide area network interface for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm 206, for example, in a cloud computing environment. The server farm 206 may include servers 206 that are geographically dispersed while and logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, SYMBIAN, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 106a that receives requests from a client machine 240, forwards the request to a second server 106b, and responds to the request generated by the client machine 240 with a response from the second server 106b. First server 106a may acquire an enumeration of applications available to the client machine 240 and well as address information associated with an application server 206 hosting an application identified within the enumeration of applications. First server 106a can then present a response to the client's request using a web interface, and communicate directly with the client 240 to provide the client 240 with access to an identified application. One or more clients 240 and/or one or more servers 206 may transmit data over network 230, e.g., network 101.

FIG. 2 shows a high-level architecture of an illustrative desktop virtualization system. As shown, the desktop virtualization system may be single-server or multi-server system, or cloud system, including at least one virtualization server 206 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

Enterprise Mobility Management Architecture

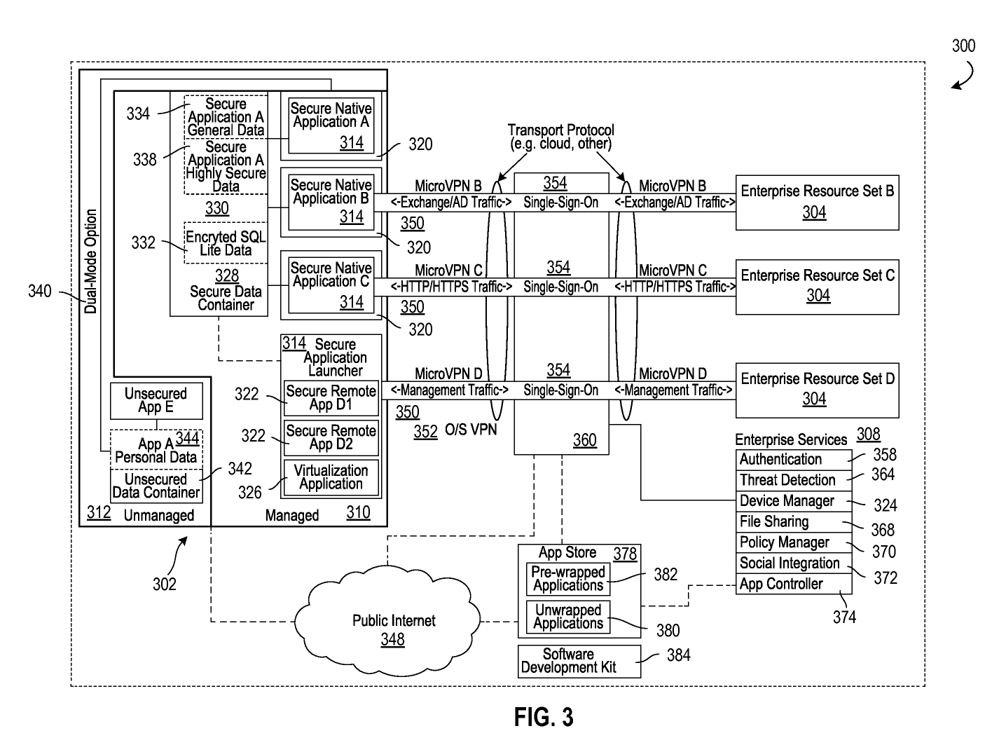

FIG. 3 represents an enterprise mobility technical architecture 300 for use in a BYOD environment. The architecture enables a user of a mobile device 302 to both access enterprise or personal resources from a mobile device 302 and use the mobile device 302 for personal use. The user may access such enterprise resources 304 or enterprise services 308 using a mobile device 302 that is purchased by the user or a mobile device 302 that is provided by the enterprise to user. The user may utilize the mobile device 302 for business use only or for business and personal use. The mobile device may run an iOS operating system, and Android operating system, or the like. The enterprise may choose to implement policies to manage the mobile device 304. The policies may be implanted through a firewall or gateway in such a way that the mobile device may be identified, secured or security verified, and provided selective or full access to the enterprise resources. The policies may be mobile device management policies, mobile application management policies, mobile data management policies, or some combination of mobile device, application, and data management policies. A mobile device 304 that is managed through the application of mobile device management policies may be referred to as an enrolled device.

In some embodiments, the operating system of the mobile device may be separated into a managed partition 310 and an unmanaged partition 312. The managed partition 310 may have policies applied to it to secure the applications running on and data stored in the managed partition. The applications running on the managed partition may be secure applications. In other embodiments, all applications may execute in accordance with a set of one or more policy files received separate from the application, and which define one or more security parameters, features, resource restrictions, and/or other access controls that are enforced by the mobile device management system when that application is executing on the device. By operating in accordance with their respective policy file(s), each application may be allowed or restricted from communications with one or more other applications and/or resources, thereby creating a virtual partition. Thus, as used herein, a partition may refer to a physically partitioned portion of memory (physical partition), a logically partitioned portion of memory (logical partition), and/or a virtual partition created as a result of enforcement of one or more policies and/or policy files across multiple apps as described herein (virtual partition). Stated differently, by enforcing policies on managed apps, those apps may be restricted to only be able to communicate with other managed apps and trusted enterprise resources, thereby creating a virtual partition that is impenetrable by unmanaged apps and devices.

The secure applications may be email applications, web browsing applications, software-as-a-service (SaaS) access applications, Windows Application access applications, and the like. The secure applications may be secure native applications 314, secure remote applications 322 executed by a secure application launcher 318, virtualization applications 326 executed by a secure application launcher 318, and the like. The secure native applications 314 may be wrapped by a secure application wrapper 320. The secure application wrapper 320 may include integrated policies that are executed on the mobile device 302 when the secure native application is executed on the device. The secure application wrapper 320 may include meta-data that points the secure native application 314 running on the mobile device 302 to the resources hosted at the enterprise that the secure native application 314 may require to complete the task requested upon execution of the secure native application 314. The secure remote applications 322 executed by a secure application launcher 318 may be executed within the secure application launcher application 318. The virtualization applications 326 executed by a secure application launcher 318 may utilize resources on the mobile device 302, at the enterprise resources 304, and the like. The resources used on the mobile device 302 by the virtualization applications 326 executed by a secure application launcher 318 may include user interaction resources, processing resources, and the like. The user interaction resources may be used to collect and transmit keyboard input, mouse input, camera input, tactile input, audio input, visual input, gesture input, and the like. The processing resources may be used to present a user interface, process data received from the enterprise resources 304, and the like. The resources used at the enterprise resources 304 by the virtualization applications 326 executed by a secure application launcher 318 may include user interface generation resources, processing resources, and the like. The user interface generation resources may be used to assemble a user interface, modify a user interface, refresh a user interface, and the like. The processing resources may be used to create information, read information, update information, delete information, and the like. For example, the virtualization application may record user interactions associated with a graphical user interface (GUI) and communicate them to a server application where the server application will use the user interaction data as an input to the application operating on the server. In this arrangement, an enterprise may elect to maintain the application on the server side as well as data, files, etc. associated with the application. While an enterprise may elect to “mobilize” some applications in accordance with the principles herein by securing them for deployment on the mobile device, this arrangement may also be elected for certain applications. For example, while some applications may be secured for use on the mobile device, others might not be prepared or appropriate for deployment on the mobile device so the enterprise may elect to provide the mobile user access to the unprepared applications through virtualization techniques. As another example, the enterprise may have large complex applications with large and complex data sets (e.g., material resource planning applications) where it would be very difficult, or otherwise undesirable, to customize the application for the mobile device so the enterprise may elect to provide access to the application through virtualization techniques. As yet another example, the enterprise may have an application that maintains highly secured data (e.g., human resources data, customer data, engineering data) that may be deemed by the enterprise as too sensitive for even the secured mobile environment so the enterprise may elect to use virtualization techniques to permit mobile access to such applications and data. An enterprise may elect to provide both fully secured and fully functional applications on the mobile device as well as a virtualization application to allow access to applications that are deemed more properly operated on the server side. In an embodiment, the virtualization application may store some data, files, etc. on the mobile phone in one of the secure storage locations. An enterprise, for example, may elect to allow certain information to be stored on the phone while not permitting other information.

In connection with the virtualization application, as described herein, the mobile device may have a virtualization application that is designed to present GUIs and then record user interactions with the GUI. The application may communicate the user interactions to the server side to be used by the server side application as user interactions with the application. In response, the application on the server side may transmit back to the mobile device a new GUI. For example, the new GUI may be a static page, a dynamic page, an animation, or the like, thereby providing access to remotely located resources.

The secure applications may access data stored in a secure data container 328 in the managed partition 310 of the mobile device. The data secured in the secure data container may be accessed by the secure wrapped applications 314, applications executed by a secure application launcher 322, virtualization applications 326 executed by a secure application launcher 322, and the like. The data stored in the secure data container 328 may include files, databases, and the like. The data stored in the secure data container 328 may include data restricted to a specific secure application 330, shared among secure applications 332, and the like. Data restricted to a secure application may include secure general data 334 and highly secure data 338. Secure general data may use a strong form of encryption such as Advanced Encryption Standard (AES) 128-bit encryption or the like, while highly secure data 338 may use a very strong form of encryption such as AES 256-bit encryption. Data stored in the secure data container 328 may be deleted from the device upon receipt of a command from the device manager 324. The secure applications may have a dual-mode option 340. The dual mode option 340 may present the user with an option to operate the secured application in an unsecured or unmanaged mode. In an unsecured or unmanaged mode, the secure applications may access data stored in an unsecured data container 342 on the unmanaged partition 312 of the mobile device 302. The data stored in an unsecured data container may be personal data 344. The data stored in an unsecured data container 342 may also be accessed by unsecured applications 348 that are running on the unmanaged partition 312 of the mobile device 302. The data stored in an unsecured data container 342 may remain on the mobile device 302 when the data stored in the secure data container 328 is deleted from the mobile device 302. An enterprise may want to delete from the mobile device selected or all data, files, and/or applications owned, licensed or controlled by the enterprise (enterprise data) while leaving or otherwise preserving personal data, files, and/or applications owned, licensed or controlled by the user (personal data). This operation may be referred to as a selective wipe. With the enterprise and personal data arranged in accordance to the aspects described herein, an enterprise may perform a selective wipe.

The mobile device may connect to enterprise resources 304 and enterprise services 308 at an enterprise, to the public Internet 348, and the like. The mobile device may connect to enterprise resources 304 and enterprise services 308 through virtual private network connections. The virtual private network connections, also referred to as microVPN or application-specific VPN, may be specific to particular applications 350, particular devices, particular secured areas on the mobile device, and the like 352. For example, each of the wrapped applications in the secured area of the phone may access enterprise resources through an application specific VPN such that access to the VPN would be granted based on attributes associated with the application, possibly in conjunction with user or device attribute information. The virtual private network connections may carry Microsoft Exchange traffic, Microsoft Active Directory traffic, HyperText Transfer Protocol (HTTP) traffic, HyperText Transfer Protocol Secure (HTTPS) traffic, application management traffic, and the like. The virtual private network connections may support and enable single-sign-on authentication processes 354. The single-sign-on processes may allow a user to provide a single set of authentication credentials, which are then verified by an authentication service 358. The authentication service 358 may then grant to the user access to multiple enterprise resources 304, without requiring the user to provide authentication credentials to each individual enterprise resource 304.

The virtual private network connections may be established and managed by an access gateway 360. The access gateway 360 may include performance enhancement features that manage, accelerate, and improve the delivery of enterprise resources 304 to the mobile device 302. The access gateway may also re-route traffic from the mobile device 302 to the public Internet 348, enabling the mobile device 302 to access publicly available and unsecured applications that run on the public Internet 348. The mobile device may connect to the access gateway via a transport network 362. The transport network 362 may be a wired network, wireless network, cloud network, local area network, metropolitan area network, wide area network, public network, private network, and the like.

The enterprise resources 304 may include email servers, file sharing servers, SaaS applications, Web application servers, Windows application servers, and the like. Email servers may include Exchange servers, Lotus Notes servers, and the like. File sharing servers may include ShareFile servers, and the like. SaaS applications may include Salesforce, and the like. Windows application servers may include any application server that is built to provide applications that are intended to run on a local Windows operating system, and the like. The enterprise resources 304 may be premise-based resources, cloud based resources, and the like. The enterprise resources 304 may be accessed by the mobile device 302 directly or through the access gateway 360. The enterprise resources 304 may be accessed by the mobile device 302 via a transport network 362. The transport network 362 may be a wired network, wireless network, cloud network, local area network, metropolitan area network, wide area network, public network, private network, and the like.

The enterprise services 308 may include authentication services 358, threat detection services 364, device manager services 324, file sharing services 368, policy manager services 370, social integration services 372, application controller services 374, and the like. Authentication services 358 may include user authentication services, device authentication services, application authentication services, data authentication services and the like. Authentication services 358 may use certificates. The certificates may be stored on the mobile device 302, by the enterprise resources 304, and the like. The certificates stored on the mobile device 302 may be stored in an encrypted location on the mobile device, the certificate may be temporarily stored on the mobile device 302 for use at the time of authentication, and the like. Threat detection services 364 may include intrusion detection services, unauthorized access attempt detection services, and the like. Unauthorized access attempt detection services may include unauthorized attempts to access devices, applications, data, and the like. Device management services 324 may include configuration, provisioning, security, support, monitoring, reporting, and decommissioning services. File sharing services 368 may include file management services, file storage services, file collaboration services, and the like. Policy manager services 370 may include device policy manager services, application policy manager services, data policy manager services, and the like. Social integration services 372 may include contact integration services, collaboration services, integration with social networks such as Facebook, Twitter, and LinkedIn, and the like. Application controller services 374 may include management services, provisioning services, deployment services, assignment services, revocation services, wrapping services, and the like.

The enterprise mobility technical architecture 300 may include an application store 378. The application store 378 may include unwrapped applications 380, pre-wrapped applications 382, and the like. Applications may be populated in the application store 378 from the application controller 374. The application store 378 may be accessed by the mobile device 302 through the access gateway 360, through the public Internet 348, or the like. The application store may be provided with an intuitive and easy to use User Interface.

A software development kit 384 may provide a user the capability to secure applications selected by the user by wrapping the application as described previously in this description. An application that has been wrapped using the software development kit 384 may then be made available to the mobile device 302 by populating it in the application store 378 using the application controller 374.

The enterprise mobility technical architecture 300 may include a management and analytics capability 388. The management and analytics capability 388 may provide information related to how resources are used, how often resources are used, and the like. Resources may include devices, applications, data, and the like. How resources are used may include which devices download which applications, which applications access which data, and the like. How often resources are used may include how often an application has been downloaded, how many times a specific set of data has been accessed by an application, and the like.

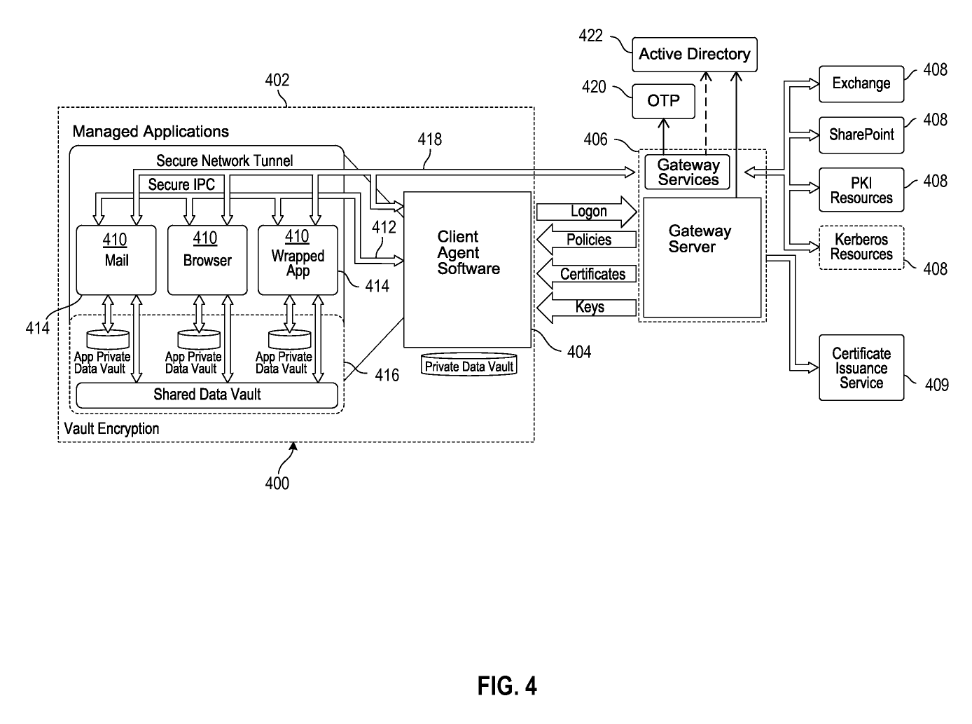

FIG. 4 is another illustrative enterprise mobility management system 400. Some of the components of the mobility management system 300 described above with reference to FIG. 3 have been omitted for the sake of simplicity. The architecture of the system 400 depicted in FIG. 4 is similar in many respects to the architecture of the system 300 described above with reference to FIG. 3 and may include additional features not mentioned above.

In this case, the left hand side represents an enrolled mobile device 402 with a client agent 404, which interacts with gateway server 406 (which includes Access Gateway and application controller functionality) to access various enterprise resources 408 and services 409 such as Exchange, Sharepoint, public-key infrastructure (PKI) Resources, Kerberos Resources, Certificate Issuance service, as shown on the right hand side above. Although not specifically shown, the mobile device 402 may also interact with an enterprise application store (StoreFront) for the selection and downloading of applications.

The client agent 404 acts as the UI (user interface) intermediary for Windows apps/desktops hosted in an Enterprise data center, which are accessed using the High-Definition User Experience (HDX)/ICA display remoting protocol. The client agent 404 also supports the installation and management of native applications on the mobile device 402, such as native iOS or Android applications. For example, the managed applications 410 (mail, browser, wrapped application) shown in the FIG. above are all native applications that execute locally on the device. Client agent 404 and application management framework of this architecture act to provide policy driven management capabilities and features such as connectivity and SSO (single sign on) to enterprise resources/services 408. The client agent 404 handles primary user authentication to the enterprise, normally to Access Gateway (AG) with SSO to other gateway server components. The client agent 404 obtains policies from gateway server 406 to control the behavior of the managed applications 410 on the mobile device 402.

The Secure interprocess communication (IPC) links 412 between the native applications 410 and client agent 404 represent a management channel, which allows client agent to supply policies to be enforced by the application management framework 414 “wrapping” each application. The IPC channel 412 also allows client agent 404 to supply credential and authentication information that enables connectivity and SSO to enterprise resources 408. Finally the IPC channel 412 allows the application management framework 414 to invoke user interface functions implemented by client agent 404, such as online and offline authentication.

Communications between the client agent 404 and gateway server 406 are essentially an extension of the management channel from the application management framework 414 wrapping each native managed application 410. The application management framework 414 requests policy information from client agent 404, which in turn requests it from gateway server 406. The application management framework 414 requests authentication, and client agent 404 logs into the gateway services part of gateway server 406 (also known as NetScaler Access Gateway). Client agent 404 may also call supporting services on gateway server 406, which may produce input material to derive encryption keys for the local data vaults 416, or provide client certificates which may enable direct authentication to PKI protected resources, as more fully explained below.

In more detail, the application management framework 414 “wraps” each managed application 410. This may be incorporated via an explicit build step, or via a post-build processing step. The application management framework 414 may “pair” with client agent 404 on first launch of an application 410 to initialize the Secure IPC channel and obtain the policy for that application. The application management framework 414 may enforce relevant portions of the policy that apply locally, such as the client agent login dependencies and some of the containment policies that restrict how local OS services may be used, or how they may interact with the application 410.

The application management framework 414 may use services provided by client agent 404 over the Secure IPC channel 412 to facilitate authentication and internal network access. Key management for the private and shared data vaults 416 (containers) may be also managed by appropriate interactions between the managed applications 410 and client agent 404. Vaults 416 may be available only after online authentication, or may be made available after offline authentication if allowed by policy. First use of vaults 416 may require online authentication, and offline access may be limited to at most the policy refresh period before online authentication is again required.

Network access to internal resources may occur directly from individual managed applications 410 through Access Gateway 406. The application management framework 414 is responsible for orchestrating the network access on behalf of each application 410. Client agent 404 may facilitate these network connections by providing suitable time limited secondary credentials obtained following online authentication. Multiple modes of network connection may be used, such as reverse web proxy connections and end-to-end VPN-style tunnels 418.

The Mail and Browser managed applications 410 have special status and may make use of facilities that might not be generally available to arbitrary wrapped applications. For example, the Mail application may use a special background network access mechanism that allows it to access Exchange over an extended period of time without requiring a full AG logon. The Browser application may use multiple private data vaults to segregate different kinds of data.

This architecture supports the incorporation of various other security features. For example, gateway server 406 (including its gateway services) in some cases will not need to validate active directory (AD) passwords. It can be left to the discretion of an enterprise whether an AD password is used as an authentication factor for some users in some situations. Different authentication methods may be used if a user is online or offline (i.e., connected or not connected to a network).

Step up authentication is a feature wherein gateway server 406 may identify managed native applications 410 that are allowed to have access to highly classified data requiring strong authentication, and ensure that access to these applications is only permitted after performing appropriate authentication, even if this means a re-authentication is required by the user after a prior weaker level of login.

Another security feature of this solution is the encryption of the data vaults 416 (containers) on the mobile device 402. The vaults 416 may be encrypted so that all on-device data including files, databases, and configurations are protected. For on-line vaults, the keys may be stored on the server (gateway server 406), and for off-line vaults, a local copy of the keys may be protected by a user password or biometric validation. When data is stored locally on the device 402 in the secure container 416, it is preferred that a minimum of AES 256 encryption algorithm be utilized.

Other secure container features may also be implemented. For example, a logging feature may be included, wherein all security events happening inside an application 410 are logged and reported to the backend. Data wiping may be supported, such as if the application 410 detects tampering, associated encryption keys may be written over with random data, leaving no hint on the file system that user data was destroyed. Screenshot protection is another feature, where an application may prevent any data from being stored in screenshots. For example, the key window's hidden property may be set to YES. This may cause whatever content is currently displayed on the screen to be hidden, resulting in a blank screenshot where any content would normally reside.

Local data transfer may be prevented, such as by preventing any data from being locally transferred outside the application container, e.g., by copying it or sending it to an external application. A keyboard cache feature may operate to disable the autocorrect functionality for sensitive text fields. SSL certificate validation may be operable so the application specifically validates the server SSL certificate instead of it being stored in the keychain. An encryption key generation feature may be used such that the key used to encrypt data on the device is generated using a passphrase or biometric data supplied by the user (if offline access is required). It may be XORed with another key randomly generated and stored on the server side if offline access is not required. Key Derivation functions may operate such that keys generated from the user password use KDFs (key derivation functions, notably Password-Based Key Derivation Function 2 (PBKDF2)) rather than creating a cryptographic hash of it. The latter makes a key susceptible to brute force or dictionary attacks.

Further, one or more initialization vectors may be used in encryption methods. An initialization vector will cause multiple copies of the same encrypted data to yield different cipher text output, preventing both replay and cryptanalytic attacks. This will also prevent an attacker from decrypting any data even with a stolen encryption key if the specific initialization vector used to encrypt the data is not known. Further, authentication then decryption may be used, wherein application data is decrypted only after the user has authenticated within the application. Another feature may relate to sensitive data in memory, which may be kept in memory (and not in disk) only when it's needed. For example, login credentials may be wiped from memory after login, and encryption keys and other data inside objective-C instance variables are not stored, as they may be easily referenced. Instead, memory may be manually allocated for these.

An inactivity timeout may be implemented, wherein after a policy-defined period of inactivity, a user session is terminated.

Data leakage from the application management framework 414 may be prevented in other ways. For example, when an application 410 is put in the background, the memory may be cleared after a predetermined (configurable) time period. When backgrounded, a snapshot may be taken of the last displayed screen of the application to fasten the foregrounding process. The screenshot may contain confidential data and hence should be cleared.

Another security feature relates to the use of an OTP (one time password) 420 without the use of an AD (active directory) 422 password for access to one or more applications. In some cases, some users do not know (or are not permitted to know) their AD password, so these users may authenticate using an OTP 420 such as by using a hardware OTP system like SecurID (OTPs may be provided by different vendors also, such as Entrust or Gemalto). In some cases, after a user authenticates with a user ID, a text is sent to the user with an OTP 420. In some cases, this may be implemented only for online use, with a prompt being a single field.

An offline password may be implemented for offline authentication for those applications 410 for which offline use is permitted via enterprise policy. For example, an enterprise may want StoreFront to be accessed in this manner. In this case, the client agent 404 may require the user to set a custom offline password and the AD password is not used. Gateway server 406 may provide policies to control and enforce password standards with respect to the minimum length, character class composition, and age of passwords, such as described by the standard Windows Server password complexity requirements, although these requirements may be modified.

Another feature relates to the enablement of a client side certificate for certain applications 410 as secondary credentials (for the purpose of accessing PKI protected web resources via the application management framework micro VPN feature). For example, an application may utilize such a certificate. In this case, certificate-based authentication using ActiveSync protocol may be supported, wherein a certificate from the client agent 404 may be retrieved by gateway server 406 and used in a keychain. Each managed application may have one associated client certificate, identified by a label that is defined in gateway server 406.

Gateway server 406 may interact with an Enterprise special purpose web service to support the issuance of client certificates to allow relevant managed applications to authenticate to internal PKI protected resources.

The client agent 404 and the application management framework 414 may be enhanced to support obtaining and using client certificates for authentication to internal PKI protected network resources. More than one certificate may be supported, such as to match various levels of security and/or separation requirements. The certificates may be used by the Mail and Browser managed applications, and ultimately by arbitrary wrapped applications (provided those applications use web service style communication patterns where it is reasonable for the application management framework to mediate https requests).

Application management client certificate support on iOS may rely on importing a public-key cryptography standards (PKCS) 12 BLOB (Binary Large Object) into the iOS keychain in each managed application for each period of use. Application management framework client certificate support may use a HTTPS implementation with private in-memory key storage. The client certificate will never be present in the iOS keychain and will not be persisted except potentially in “online-only” data value that is strongly protected.

Mutual SSL may also be implemented to provide additional security by requiring that a mobile device 402 is authenticated to the enterprise, and vice versa. Virtual smart cards for authentication to gateway server 406 may also be implemented.

Both limited and full Kerberos support may be additional features. The full support feature relates to an ability to do full Kerberos login to Active Directory (AD) 422, using an AD password or trusted client certificate, and obtain Kerberos service tickets to respond to HTTP Negotiate authentication challenges. The limited support feature relates to constrained delegation in Citrix Access Gateway Enterprise Edition (AGEE), where AGEE supports invoking Kerberos protocol transition so it can obtain and use Kerberos service tickets (subject to constrained delegation) in response to HTTP Negotiate authentication challenges. This mechanism works in reverse web proxy (aka corporate virtual private network (CVPN)) mode, and when http (but not https) connections are proxied in VPN and MicroVPN mode.

Another feature relates to application container locking and wiping, which may automatically occur upon jail-break or rooting detections, and occur as a pushed command from administration console, and may include a remote wipe functionality even when an application 410 is not running.

A multi-site architecture or configuration of enterprise application store and an application controller may be supported that allows users to be service from one of several different locations in case of failure.

In some cases, managed applications 410 may be allowed to access a certificate and private key via an API (example OpenSSL). Trusted managed applications 410 of an enterprise may be allowed to perform specific Public Key operations with an application's client certificate and private key. Various use cases may be identified and treated accordingly, such as when an application behaves like a browser and no certificate access is required, when an application reads a certificate for “who am I,” when an application uses the certificate to build a secure session token, and when an application uses private keys for digital signing of important data (e.g. transaction log) or for temporary data encryption.

### Illustrative Embodiments of the Innovations

As noted above, the present disclosure is directed towards containerized web applications and methods for containerizing web applications such that their execution is subject to control by an application manager.

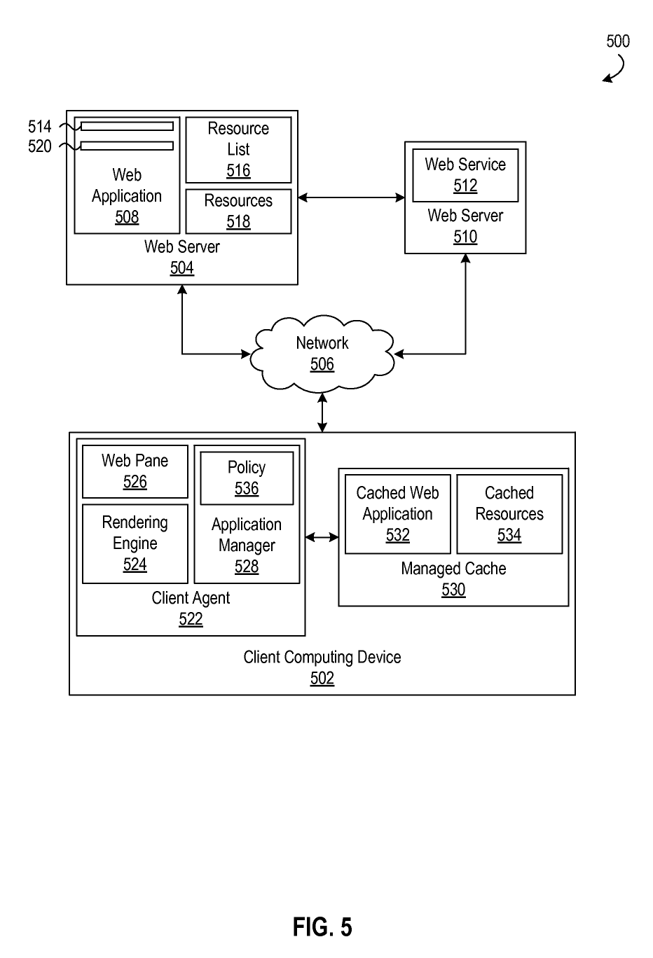

Referring now to FIG. 5, a block diagram of an example of an implementation of a system 500 for containerizing web applications and managing operation of a containerized web application is shown. As seen in FIG. 5, a client computing device 502 is in signal communication with a web server 504 via a network 506. The web server 504, in this example, serves a web application 508 to the client computing device 502 via the network 506. The network 506 may include, for example, a wide area network (WAN) such as the Internet, a local area network (LAN), and a combination of wide and local area networks that may include wired networks, wireless networks, and combinations of wired and wireless networks. In this way, the web server 504 may function as a web application distribution platform that delivers web applications to client computing devices. The web server 504 may push the web application 508 to the client computing device 502 or transmit the web application to the client computing device in response to receipt of a request for the web application from the client computing device. To access and utilize the web application 508, the client computing device 502 may download at least a portion of the web application. Accordingly, the web application may include server-side components that reside at the web server 504 as well as client-side components that are downloaded to the client computing device 502. During operation the client-side components cached at the client computing device 502 may interact with the server-side components that reside at the web server 504.

The client computing device 502 as well as the web server 504, in this example, are also in signal communication with another web server 510 that hosts a web service 512. As noted above, a web service, as used in this description, is a type of web application. The web application 508 may be configured to interact with the web service 512 during execution, for example, to retrieve information, perform data processing, and the like. Such interactions may occur between the server-side components of the web application 508 and the web service 512 (i.e., between the web server 504 and the web server 510) as well as between the client-side components of the web application and the web service (i.e., between the client computing device 502 and the web server 510). Although only one web service 512 is shown in FIG. 5, the web application 508 may be configured to interact with additional web services hosted by the web server 510 or other web servers. In addition, the web server 504 may host one or more web services utilized by the web application 508 during execution.

The web application 508, in this example, includes a reference 514 to a resource list 516 that identifies one or more resources 518 the web application 508 needs to operate offline. Under the HTML5 standard, the manifest functions as the resource list for a web application. As noted above, the resources 518 may include one or more web pages, one or more style sheets, one or more scripts, and one or more assets. The resources 518 identified in the resource list 516 allow the web application 508 to operate at the client computing device 502 when a network connection between the client computing device and the web server 504 is not available. The functionality of the web application 508 when a network connection is not available may be the same as or less than the functionality of the web application when a network connection is available. In other words, the offline functionality of the web application 508 may include some but not all of the online functionality. In FIG. 5, the resource list 516 and the resources 518 reside at the web server 504. In other example implementations, however, the resource list 516, the resources 518, or both may reside at another computing device (e.g., another web server) located remotely relative to the web server 504. The reference 514 to the resource list 516 may be a uniform resource identifier (URI) such as a uniform resource locator (URL). The resource list 516 may include an address for each resource 518 listed. The respective addresses of the resource 518 listed in the resource list 516 may similarly be a URI such as a URL.

The web application 508, in this example, also includes a reference 520 to one or more web services utilized by the web application during operation. The reference 520 may include the location (e.g., the address) of the web service. Like the reference to the resource list 516 and the resources 518 identified therein, the reference 520 to the web service may include a URI for the web service such as a URL. Although the web application 508, in this example, is depicted as only including one reference 520 to a web service, a web application may include multiple references to multiple web services utilized by that web application. In addition, although the web application 508 itself is depicted as including the reference 520 to the web service, in some example implementations, a resource list for a web application may include one or more references to the web services utilized by that web application.

The client computing device 502 may be any one of a desktop computing device, a laptop computing device, a tablet computing device, a palmtop computing device, a television set-top box, a video game device, a television device, and other types of computing devices configured for network communications. The client computing device 502, in this example, includes a client agent 522 that containerizes the web application and manages its execution. The client agent 522, in this example, is also configured to present the web application 508 at the client computing device 502. Accordingly the client agent 522 includes a rendering engine 524 that renders the web application 508 and a web pane 526 that presents the rendered web application. The rendering engine 524 and the web pane 526 may be components of an web browser embedded in the client agent 522. To access the web application 508, a user provides the client agent 522 the location of the web application at the web server 504. The location of the web application 508 may be provided in the form of, e.g., a URI such as a URL.

Although the client agent 522 may include an embedded web browser (or the equivalent of such) to present the cached web application 532, the cached web application may, in some example implementations, be presented at a native web browser residing at the client computing device. The modifications to the cached web application 532 ensure, in these implementations, that the application manager 528 intercepts the functionality of invoked by the cached web application even when the cached web application is presented in the native web browser of the client computing device.

The client agent 522, in this example, also includes an application manager 528. The application manager 528, in this example, is configured to containerize the web application 508 and manage its execution at the client computing device 502. Containerizing the web application 508 will be discussed in further detail below. In general, however, the client agent 522 downloads at least a portion of the web application 508, in particular, the resources 518 identified in the resource list 516 as used by the web application when operating offline. The client agent 522 stores the web application and its resources at a local data store of the client computing device. As depicted in FIG. 5, the client agent 522 utilizes a cache 530 to store a local copy of the web application 508 and local copies of the resources 518 used to operate offline. The cached local copy of the web application 508 and the cached local copies of the resources 518 are referred to in FIG. 5 and in this description as the cached web application 532 and the cached resources 534 respectively. The application manager 528 modifies the cached web application 532 such that it can control the operation of the cached web application. As described in further detail below, the application manager 528 controls operation of the cached web application 532 by intercepting the function calls invoked by the cached web application.

To control operation of the cached web application 532, the application manager 528 may apply a policy 536 to the functionality invoked by the cached web application. The policy 536 may be one of a network policy that manages network communications associated with the cached web application 532, a local storage policy that manages local storage requests from the cached web application, and a hardware policy that manages access to local hardware (e.g., input/output devices) by the cached web application. Although only one policy 536 is depicted in FIG. 5, the application manager 528 may apply multiple policies to control operation of the cached web application 532, e.g., one or more network policies, one or more storage policies, and one or more hardware policies. The application manager 528 may also be configured to control storage at the cache 530. Where the application manager 528 can control storage at the cache 530, that cache may be referred to as a managed cache. The application manager 528 may thus apply one or more caching policies when controlling storage at the cache 530. The caching policies may indicate, for example, how long to retain particular content at the cache (e.g., indefinitely), what content may be shared between cached web applications, and what content cannot be shared between web applications. The caching policies may also determine when locally-stored content should be encrypted and decrypted. As an example a caching policy may require that content stored locally at the cache 530 should be encrypted whenever a user logs out of or exits the cached web application 532 thus effectively “locking” the content. The caching policy, in this example, may permit decrypting the content when the user subsequently logs into or launches the cached web application 532 thus “unlocking” the locally-stored content.

As noted above, containerizing a web application includes configuring the web application such that its operation is subject to the control of the application manager 528 of the client agent 522. A web application may be pre-configured for containerization by including explicit function calls to the API of the application manager 528 during development of the web application. In this example, the web application is containerized before the web application is downloaded to the client computing device 502. The client agent 522 may also be configured to containerize an existing web application after the web application is downloaded and cached at the client computing device 502. The client agent 522 may containerize the cached web application 532 by injecting into the cached web application explicit function calls to the API of the application manager 528. The function calls injected into the cached web application 532 may supplement or replace the existing function calls of the cached web application. Containerizing the cached web application 532 may also include modifying one or more function calls of the cached web application. As an example, the client agent 522 may replace function calls that invoke a remote web service (e.g., web service 512) with function calls that invoke a cached web service locally at the client computing device 502.

The client agent 522 may perform other modifications of the cached web application 532 to containerize it at the client computing device 502. As an example, the client agent 522, in this example, removes the reference 514 to the resource list 516 once the web application 508 and its offline resources 518 have been cached at the client computing device 502. In this way, the client agent 522 avoids attempt to re-download and re-cache the offline resources 518 when the cached web application 532 is launched at the client computing device 502. Other modifications to the cached web application 532 during containerization may include changing one or more permissions of the cached web application.

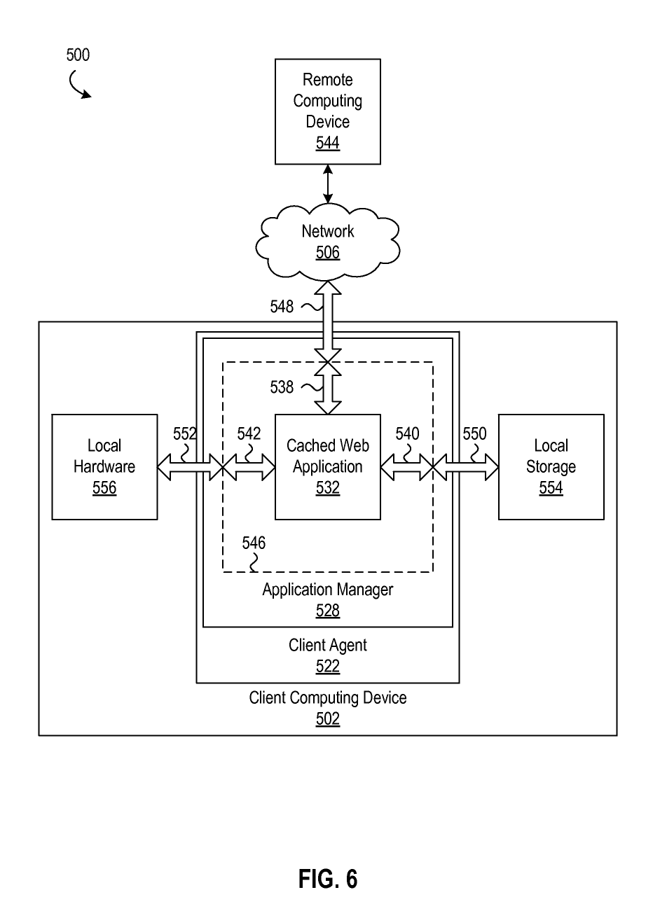

Referring now to FIG. 6, another block diagram of the system 500 for containerizing web applications and managing operation of a containerized web application is shown. FIG. 6 depicts the logical relationship between the components of the client agent 522 relative to the cached web application 532. As noted above, the application manager 528 of the client agent 522 controls operation of the cached web application 532 by intercepting function calls invoked at the cached web application. The function calls invoked by the cached web application 532 include network communications 538, local storage requests 540, and hardware access requests 542. The network communications 538 include requests transmitted to a remote computing device 544 via the network 506 as well as responses received from the remote computing device via the network. The local storage requests 540 include request to store content at a local data store of the client computing device (e.g., cache 530 in FIG. 5) as well as requests to retrieve content stored at a local data store of the client computing device. The hardware access requests 542 include requests to receive input from local hardware of the client computing device 502 as well as requests to provide output at local hardware of the client computing device. Input from local hardware of the client computing device includes, for example, images and video from a camera, audio from a microphone, keyboard or touchscreen input, input via a peripheral port such as a Universal Serial Bus (USB), and other types of input from other types of input devices of the client computing device. Output to local hardware of the client computing device includes, for example, visual content to a display screen, audio content to one or more speakers, haptic content (e.g., vibrations) to a haptic device (e.g., a vibration motor), and other types of output to other types of output devices.

The network communications 538, local storage requests 540, and hardware access requests 542 thus represent the logical entrance and exits points of the application and establish a boundary 546 around the cached web application 532 that the application manager 528 leverages to exert control over the operation of the cached web application. The application manager 528 containerizes the cached web application 532 by intercepting the communications and requests into and out of these entrance and exit points. Although web browser plug-ins are not shown in FIG. 6, the application manager 528 may similarly intercept communications exchanged between the cached web application 532 and one or more web browser plug-ins installed at the client computing device 502. When the cached web application 532 has been containerized such that its operation is subject to control by the application manager 528, the cached web application may be referred to as a managed web application. A managed web application may be fully managed or partially managed. A managed web application is considered to be fully managed when the application manager 528 intercepts all types of communications and requests to and from the managed web application. In other words, the application manager 528 intercepts all communications and requests that cross the boundary 546 when the managed web application is fully managed. A managed web application is considered to be partially managed when the application manager 528 intercepts some, but not all types, of communications and requests to and from the managed web application. In other words, the application manager 528 does not intercept at least one type of communication or request that crosses the boundary 546 when the managed web application is partially managed.

The application manager 528 may process the function call invoked at the cached web application 532 and subsequently intercepted. When processing the function calls intercepted from the cached web application 532, the application manager 528 may issue its own network communications 548, local storage requests 550, and hardware access requests 552. As depicted in FIG. 6, the application manager 528 may intercept storage requests 540 from the cached web application 532 and issue its own storage requests 550 to local storage 554 of the client computing device 502. In a similar fashion, the application manager 528 may intercept hardware access requests 542 from the cached web application 532 and issue its own hardware access requests 552 to local hardware 556 of the client computing device 502. The function calls intercepted by the application manager 528 may include one or more parameters. The application manager 528 may thus extract the parameters from the intercepted function call and utilize those parameters when processing the intercepted function call. The network communications 548, storage requests 550, and hardware access requests 552 issued by the application manager 528 may be the same as, similar to, or completely different from the network communications 538, storage requests 540, and hardware access requests 542 intercepted by the application manager. The policies applied by the application manager 528 may determine whether the application manager 528 modifies the communications and requests intercepted from the cached web application 532, implements alternative functionality, or issues its own communications and requests that are substantially the same as those intercepted. Implementing alternative functionality refers to implementing functionality in lieu of the functionality invoked by a function call at the cached web application 532. As an example, a security policy applied by the application manager 528 may require a particular encryption method to be applied to network communications transmitted by the cached web application. If the application manager 528 determines that the cached web application 532 utilizes the specified encryption method for its network communications 538, then the network communications 548 issued by the application manager may be substantially the same as the network communications intercepted without modification. In some example implementations, the application manager 528 may also be configured to add authentication information to network calls in order to provide single sign-on functionality with respect to the cached web application 532 and the remote systems, devices, services, and resources accessed using the cached web application. The application manager 528, in some example implementations, may also be configured to, tunnel networks calls to an alternative network thus providing VPN-like functionality with respect to the cached web application.

Handling the intercepted function call includes invoking functionality of the application manager 528 in lieu of the functionality invoked at the cached web application. In this scenario, the application manager 528 invokes alternative functionality in response to intercepting a function call of the cached web application 532. The alternative functionality may be similar to or completely different from the functionality invoked at the cached web application. The alternative functionality invoked at the application manager 528 may depend on one or more of the policies applied by the application manager 528 (e.g., policy 576 in FIG. 5). The alternative functionality may, for example, include the use of a preferred authentication protocol such as one that utilizes smart cards for authentication. The alternative functionality may, as another example, include the use of encryption such that content stored locally at the client computing device 502 is stored as encrypted content rather than as unencrypted content.

Handling the intercepted function call also includes proxying the intercepted function call on behalf of the cached web application 532. Proxying the intercepted function call may include redirecting communications to alternative communication paths. As an example, the application manager 528 may direct communications from the cached web application 532 through an authentication gateway that provides secured access to enterprise resources of an enterprise computing system or through other proxy servers. Proxying the intercepted function call may also include substituting an existing protocol (e.g., http://) with an alternative protocol (e.g., https://, ftp://, file://, etc.).

Proxying intercepted function calls at the application manager 528 is also advantageous as it provides a solution to obstacles encountered when using current web technologies to access web applications that are aliases of one another. When instances of the same web application are accessible via different aliases (e.g., different addresses), current web technologies might treat each instance as a separate web application. To avoid caching multiple copies of the web application and its offline resources, the application manager 528 is configured to leverage its knowledge of the manner in which gateways and proxy servers rewrite the aliases and addresses associated with multiple instances of the same web application. In this way, the application manager 528 may advantageously detect when separate aliases address the same web application and cache only a single copy of the web application and its corresponding resources at the client computing device 502. By proxying communications from the cached web application 532, the application manager 528 may hide gateway differences and aliasing differences associated with multiple instances of the same web application. The application manager 528 thus provides local storage efficiencies by avoiding unnecessary caching at the client computing device 502 when accessing multiple instances of the same web application and enabling one alias of the web application to access content stored locally at the client computing device by another alias of the web application.

The application manager 528 provides additional local storage efficiencies when multiple instances of the same web application are accessed at the client computing device. Upon recognizing multiple web applications are actually separate instances of the same web application, the application manager 528 may share the resources and data stored at the client computing device 502 with each instance of the web application. As a result, redundant storage of these resources and data at the client computing device 502 is advantageously avoided. In addition, the sharing of resources and data between multiple instances of the same web application advantageously avoids the need to resynchronize the web servers that host the server-side components of the web application. The application manager 528 enables each instance of the web application, in this example, to access the same set of resources and data stored at the client computing device. In this way, users may seamlessly move between each instance of the web application.

The ability of the application manager 528 to recognize gateway and alias differences provides additional efficiencies with respect to launching the cached web application 532 at the client computing device 502. Rather than the cached web application 532, the application manager 528, in this example, is responsible for determining which alias of a web application to connect to. In this way, faster startup of the cached web application 532 may advantageously occur. Furthermore configuring the application manager 528 to determine which alias of a web application to connect to advantageously permits smooth roaming of the client computing device 502 between intranet and extranet environments. The application manager 528, in this example, is configured to detect when the client computing device 502 moves between an intranet environment and an extranet environment, and direct network communications as needed to the appropriate alias of the web application, e.g., a web server only accessible when the client computing device is connected to an internal network of the enterprise computing system or an access gateway used to access enterprise resources from outside the enterprise computing system such as via the Internet. The application manager 528, in this example, may also be configured to direct network communications to a master copy of a web application deployed as multiple instances across multiple respective customer sites. Redirecting network calls to a master copy of a web application advantageously ensures that the most recent version of the web application is accessed. Redirecting network calls also allows a web application and the web services it utilizes to reside at different locations which advantageously overcomes current limitations of some current web standards that might require a web application to be hosted at the same location as the web services it utilizes.

In one particular example of processing intercepted function calls, a web application may be configured for asynchronous communication with a web server using, e.g., AJAX calls (Asynchronous JavaScript and XML), and the application manager 528 may intercept the asynchronous AJAX calls. The application manager 528 may implement the functionality requested by the AJAX call locally at the client computing device 502. The application manager 528 may also implement, locally at the client computing device 502, alternative functionality that is similar to or completely different from the functionality requested by the AJAX call. If the connection between the client computing device 502 and the web server that processes the AJAX call is interrupted or otherwise unavailable, the application manager 528 may proxy the AJAX call to use an alternative path to the web server or to use an alternative server that can process the AJAX call. Even where a connection between the client computing device 502 and the web server that processes the AJAX call is available, the application manager 528 may proxy the AJAX call to apply a security policy before forwarding the AJAX call to the web server.

The application manager 528 may implement additional functionality that facilitates containerization of the cached web application 532. One example relates to the caching strategies employed at the client computing device 502 for resources and data associated with the cached web application 532. By implementing its own caching strategies, the application manager 528 may control how long cached content is kept at the client computing device 502. For some content (e.g., image content), the application manager 528 may store the content at the client computing device indefinitely in order to ensure that the content is available offline. The application manager 528 may also recognize when resources and data stored at the client computing device 502 may be shared (and thus reused) between different cached web applications or multiple instances of the same web application. As noted above, the application manager 528 may also set or remove various permissions when containerizing and controlling operation of the cached web application 532. Such permissions may include, e.g., permissions to launch other web applications or native applications at the client computing device, permissions to access application plug-ins, permissions to access local hardware, permissions to access local functionality at the client computing device, permissions to operate in an online mode, and other types of permissions that will be appreciated with the benefit of this disclosure. The application manager 528 may also control operation of the cached web application by, e.g., requiring the cached web application to operate offline, requiring the use of a virtual private network (VPN), requiring particular encryption algorithms to be employed, requiring a particular network adapter of the client computing device to send and receive network communications, and the like. In addition, the application manager 528 may employ one or more of the EMM and MDM techniques discussed above with reference to FIGS. 3-4 to containerize the cached web application 532 and control its operation at the client computing device 502. The EMM and MDM techniques described above are not limited to mobile computing devices and may be employed with respect to cached web applications at all types of client computing devices including non-mobile client computing devices such as desktop computing devices.

As noted above, the techniques described herein may also be implemented to containerize the web services utilized by a web application such that those services are available offline to the copy of the web application cached at a client computing device. By also caching web services, the capabilities of a web application with respect to those services are maintained when the web application operates offline. Furthermore, caching the web services utilized by a web application also enables those web services to be containerized such that their operation is also subject to the control of an application manager.

As noted above, the system 500 depicted in FIG. 5 and FIG. 6 is provided by way of example only. Other implementations may employ alternative configurations and arrangements for the client agent and the application manager. As one example, the client agent 522 of FIG. 5 and FIG. 6 is depicted as including the application manager 528. In other implementations, the client agent and the application manager may be separate entities (e.g., separate native applications) installed and residing at the client computing device. The separate client agent and application manager, in this alternative implementation, may be in signal communication with each other, and the client agent may facilitate the download, caching, and containerization of a web application while the application manager separately manages operation of the cached web application during execution. Other implementations, configurations, and arrangements may be selectively employed without departing from the scope of the claimed subject matter.

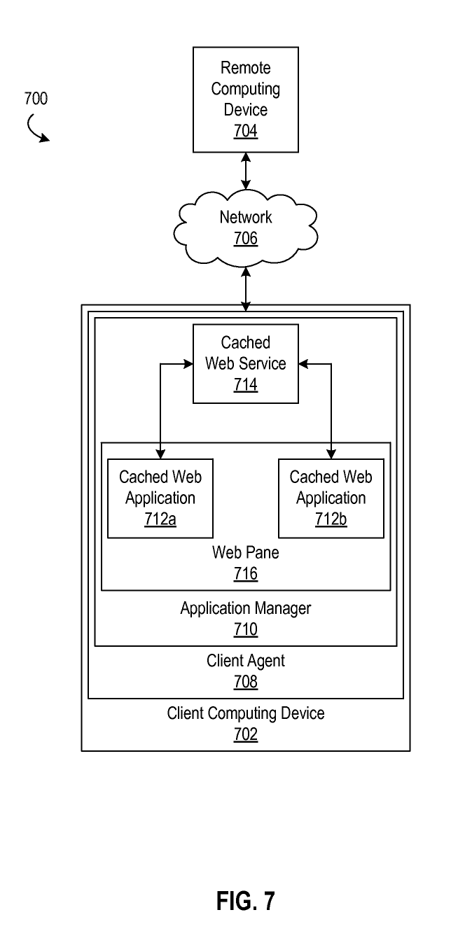

Referring now to FIG. 7, a system 700 for containerizing web applications and web services is depicted. Like the system 500, a client computing device 702 is in signal communication with a remote computing device 704 via a network 706. The client computing device 702 may be the same as or at least similar to the client computing device 502 of FIG. 5, and the network 706 may be the same as or at least similar to the network 506 of FIG. 5. The remote computing device 704 may be a web server, a computing device of an enterprise computing system, and the like.

A client agent 708 that includes an application manager 710 may similarly be installed at the client computing device 702. The client agent 708 may be the same as or at least similar to the client agent 522 of FIG. 5, and the application manager may be the same as or at least similar to the application manager 528 of FIG. 5. As shown in FIG. 7, two web applications 712a and 712b as well as a web service 714 have been cached at the client computing device 702. Each of the web applications may be presented in one or more web panes 716 of the client agent 708. The use of containerized web services is not limited to containerized web applications. Containerized native applications residing at a client computing device may also utilize the containerized web services cached at the client computing device, e.g., a containerized native email application may utilize a containerized email service cached at a client computing device.

The client agent 708 may containerize the web service in the same fashion as the web applications as discussed above. The client agent 708 may download and cache one or more functional elements of the web service as well as one or more resources utilized by the web server when operating offline. The cached web service 714 may be a service that each cached web application 712a and 712b utilizes independently of the other. In this regard, the cached web service 714 may be viewed as a shared service between a suite of cached web applications at the client computing device. The cached web service 714 may also be a service the cached web applications 712a and 712b utilize to communicate with each other and share data.

One example of a web service that may be containerized at a client computing device is a clipboard services that facilitates copy-and-paste and cut-and-paste functionality between containerized web applications. For security reasons, an enterprise may restrict the native clipboard service at a client computing device such that content cannot be shared between the cached web applications and the native applications at the client computing device. To enable cached web applications to utilize clipboard features, however, a clipboard service may be cached and containerized at the client computing device that allows a user to copy-and-paste or cut-and-paste content between the cached web applications. Another example of a web service that may be containerized at a client computing device is a synchronization service that synchronizes the calendars of a cached email web application and a cached calendar web application. The synchronization service, in this example, may be cached and containerized at the client computing device and update the respective calendars of the cached email and cached calendar applications when calendar events at one or the other are added, modified, or removed. An additional example of a web service that may be containerized at a client computing device is a completion service that facilitates the automatic completion of input fields based on a stored dictionary of information. A web application may, for example, include text fields for receiving input corresponding to various information items (e.g., first name, last name, address, etc.). The cached completion service may determine the information item associated with a text field, perform a lookup in a dictionary stored at the client computing device, and automatically populate the text field with the value for that information item identified in the dictionary.

As noted above, developers may pre-configure web applications to identify the web services utilized during their operation. References to these web services may be included in the web applications themselves or in a resource list referenced by the web applications. During containerization of the web application at a client computing device, the web services utilized by that web application may also be containerized at the client computing device using the same techniques.

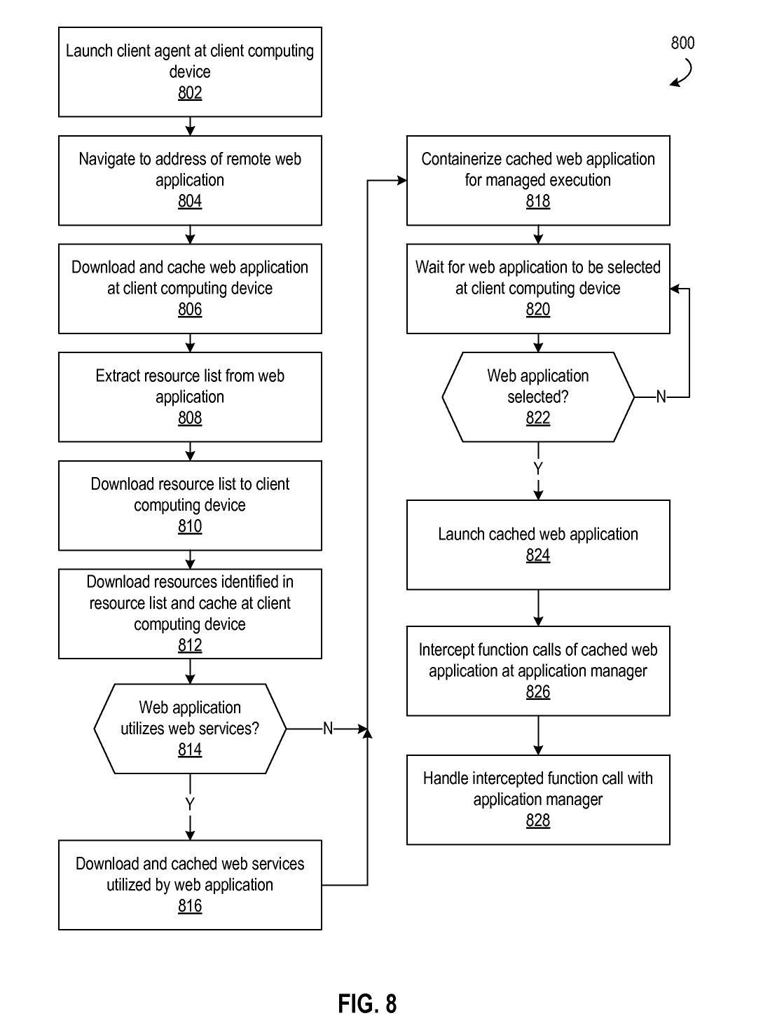

Referring now to FIG. 8, a flowchart 800 of example method steps for containerizing a web application is shown. These steps may be performed to containerize the web application following the initial access of the web application from a client computing device. It will be appreciated that the steps set forth below are provided by way of example only and that additional or alternative steps may be employed to containerize a web application without departing from the scope of the claimed subject matter.

A user installs and launches the client agent at a client computing device (block 802). Via the client agent, the user navigates to the address of a remotely-located web application (block 804). The client agent downloads and caches at least a portion of the web application at the client computing device (block 806) and extracts a reference to the resource list included in the web application (block 808). The client agent then downloads, to the client computing device, the resource list referenced in the web application (block 810). The client agent then iterates over the resource list to download and cache, at the client computing device, the resources identified the resource list (block 812) which the cached web application utilizes during execution.

If the web application utilizes one or more web services (block 814:Y), the client agent downloads and caches, at the client computing device, the web services utilized by the cached web application during operation (block 816). As described above, a web application may explicitly identify the web services utilized during operation or may include a reference to a web service list that identifies the web services utilized. In some example implementations, the client agent may iterate over the functional elements of the web application to and employ parsing techniques to automatically identify and extract the web services utilized by the web application. To containerize the web services, the client agent may perform steps similar to at least some of the steps depicted in FIG. 8 and described herein.

Once the web services utilized by the cached web application have been downloaded and cached at the client computing device—or if the web application does not utilize web services (block 814:N)—the client agent containerizes the cached web application for managed execution (block 818). The client agent may also containerize any web services utilized by the cached web application and also cached at the client computing device. The client agent may employ one or more of the techniques described above to containerize the cached web application and cached web services such that their operation is subject to the control of an application manager.

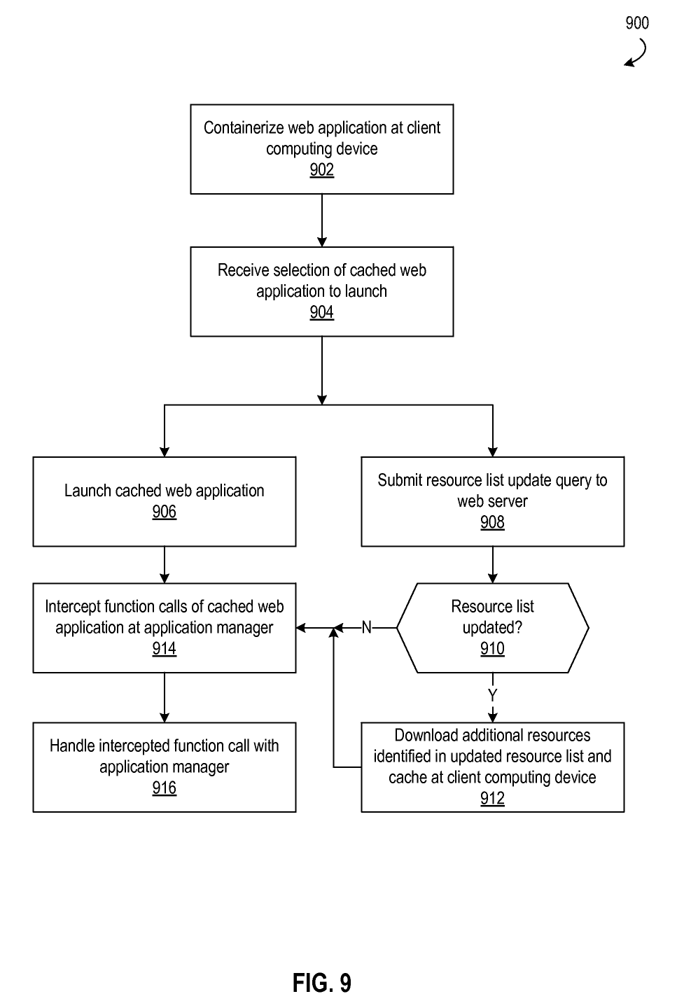

Having cached the web application and any supporting web services, the client agent waits for the user to select the cached web application at the client computing device (block 820). If the cached web application is not selected (block 822:N), the client agent continues to wait. Once the user does select the cached web application (block 824:Y), the client agent may launch the cached web application (block 824). Instead of navigating to the address of the remote web application, the client agent retrieves and launches the cached web application residing at the client computing device. As described below with reference to FIG. 9, the client agent may determine whether an update resource list is available for the cached web application upon launch of the cached web application following the initial download, caching, and containerization. During operation of the cached web application at the client computing device, an application manager of the client agent intercepts the function calls of the cached web application (block 826) and processes the intercepted function calls (block 828) as described above.

In some example implementations, rather than have the client agent download and cache a web application and its resources, a web application may be delivered to a client computing device in an application bundle or installer package that includes the resources utilized by the web application when operation offline. Containerization of the web application may thus occur during installation of the web application using the application bundle or installer package. The client agent, in these example implementations, may provide an interface to a web application distribution platform that presents web applications available to be selected, cached, and containerized at a client computing device. The distribution platform may deliver the application bundles or installer packages to the client computing device via the client agent upon receipt of respective selections of web applications from a user.

Referring now to FIG. 9, a flowchart 900 of example method steps for managing operation of a containerized web application is shown. The steps may be performed following the download, caching, and containerization of a web application. It will be appreciated that the steps set forth below are provided by way of example only and that additional or alternative steps may be employed to manager operation of a containerized web application without departing from the scope of the claimed subject matter.

A client agent installed at a client computing device containerizes a web application at the client computing device (block 902) as described above with reference to FIG. 8. A user selects the cached web application (block 904), and the client agent initiates launch of the cached web application at the client computing device (block 906). Upon selection of the cached web application, the client agent also initiates a query to the web server that hosts the remotely-located copy of the web application (block 908). The query inquires whether an update resource list is available for the cached web application selected. If an update resource list for the cached web application is available (block 910:Y), the client agent downloads and iterates over the updated resource list to download any resources identified in the updated resource list and not yet cached at the client computing device. The client agent may retrieve the updated resource list directly from the web server or inject into a web browser an “updated resource list” event in order to trigger retrieval of the updated resource list by the web browser. The client agent downloads and caches, at the client computing devices, those additional resources identified in the updated resource list (block 912). Once the client agent has downloaded and cached the additional resources identified in the updated resource list—or if the resource list for the cached web application is up-to-date (block 910:N)—an application manager of the client agent intercepts the function calls of the cached web application (block 914) and processes the intercepted function calls (block 916) as described above.

The client agent may also be configured to delete from the client computing device any cached resources that are not identified in the updated resource list. The approach depicted in FIG. 9 advantageously provides an efficient mechanism with which the functionality of cached web applications may be update, modified, or extended. Where scripts provide functionality of the cached web application, existing functionality may be modified and new functionality may be added to the cached web application by simply updating or adding to the script resources associated with the web application and the resource list for the web application in order to identify those updated or new scripts. Additional examples will be appreciated with the benefit of this disclosure.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
retrieving at least a portion of a web application and at least one resource utilized by the web application;
caching, at a computing device, the portion of the web application and the resource retrieved;
intercepting, at an application manager of a client agent residing at the computing device, a function call invoked at the cached portion of the web application; and
processing, at the application manager, the function call intercepted.

2. The method of claim 1, wherein processing the function call intercepted comprises:
invoking functionality of the application manager in lieu of functionality invoked by the function call intercepted at the cached portion of the web application.

3. The method of claim 1, wherein:
the function call intercepted is a network function call configured to invoke remote functionality at a remotely-located computing device; and
processing the network function call comprises applying a network policy to the network function call.

4. The method of claim 3, wherein:
applying the network policy comprises invoking functionality of the application manager in lieu of the remote functionality.

5. The method of claim 3, wherein:
applying the network policy comprises proxying the network function call on behalf of the cached portion of the web application.

6. The method of claim 1, wherein:
the function call intercepted is a storage function call configured to store content at a local data store; and
processing the storage function call comprises applying a storage policy to the storage function call.

7. The method of claim 1, wherein:
the function call intercepted is a hardware function call configured to access local hardware; and
processing the hardware function call comprises applying a hardware policy to the hardware function call.

8. The method of claim 1 further comprising:
modifying, by the client agent, the cached portion of the web application such that at least a portion of its functionality is subject to control by the application manager.

9. The method of claim 8, wherein:
modifying the cached portion of the web application comprises adding to the cached portion of the web application a new function call that invokes functionality of the application manager.

10. The method of claim 8, wherein:
modifying the cached portion of the web application comprises replacing an existing function call in the cached portion of the web application with a replacement function call that invokes functionality of the application manager.

11. The method of claim 8, wherein:
retrieving the portion of the web application and the at least one resource comprises
retrieving a resource list referenced by the web application wherein the resource list identifies on or more resources utilized by the web application, and
retrieving at least one of the resources identified in the resource list; and
modifying the cached portion of the web application comprises removing from the cached portion of the web application a reference to the resource list.

12. The method of claim 1, wherein:
the resource list identifies a remote web service utilized by the web application.

13. The method of claim 12, further comprising:
retrieving, by the client agent, at least a portion of the remote web service;
caching, at the computing device, the portion of the remote web service retrieved; and
modifying the cached portion of the web application to utilize the cached portion of the web service in lieu of the remote web service.

14. A computing device comprising:
one or more processors; and
memory storing instructions that, when executed by at least one of the processors, cause the computing device to
retrieve at least a portion of a web application and at least one resource utilized by the web application,
cache the web application and the resource retrieved,
intercept a function call invoked at the cached portion of the web application; and
process the function call intercepted.

15. The computing device of claim 14, wherein:
when processing the function call intercepted, the instructions, when executed by at least one of the processors, further cause the computing device to invoke functionality of an application manager in lieu of functionality invoked by the function call intercepted at the cached portion of the web application; and
the function call intercepted is one of
i) a network function call configured to initiate a network communication to a remotely-located computing device,
ii) a storage function call configured to store content at a local data store, and
iii) a hardware function call configured to access local hardware.

16. The computing device of claim 14, wherein:
the instructions, when executed by at least one of the processors, further cause the computing device to modify the cached portion of the web application such that at least a portion of its functionality is subject to control by an application manager; and
modification of the cached portion of the web application comprises one or more of
i) addition of a new function call to the cached portion of the web application that invokes functionality of the application manager, and
ii) replacement of an existing function call in the cached portion of the web application with a replacement function call that invokes functionality of the application manager.

17. The computing device of claim 14, wherein:
the resource list identifies a remote web service utilized by the web application; and
the instructions, when executed by at least one of the processors, further cause the computing device to
retrieve at least a portion of the remote web service,
cache the portion of the remote web service retrieved, and
modifying the cached portion of the web application to utilize the cached portion of the web service in lieu of the remote web service.

18. One or more non-transitory computer-readable media storing instructions that, when executed, cause a computing device to:
retrieve at least a portion of a web application and at least one resource utilized by the web application;
cache the web application and the resource retrieved; and
intercept a function call invoked at the cached portion of the web application; and
process the function call intercepted.

19. The non-transitory computer-readable media of claim 18, wherein:
when processing the function call intercepted, the instructions, when executed, further cause the computing device to invoke functionality of an application manager in lieu of functionality invoked by the function call intercepted at the cached portion of the web application; and
the function call intercepted is one of
i) a network function call configured to initiate a network communication to a remotely-located computing device,
ii) a storage function call configured to store content at a local data store, and
iii) a hardware function call configured to access local hardware.

20. The non-transitory computer-readable media of claim 18, wherein:
the resource list identifies a remote web service utilized by the web application; and
the instructions, when executed, further cause the computing device to
retrieve at least a portion of the remote web service,
cache the portion of the remote web service retrieved, and
modifying the cached portion of the web application to utilize the cached portion of the web service in lieu of the remote web service.
